(19) United States
(12) Patent Application Publication
(10) Pub. No.: US 2023/0361435 A1
(43) Pub. Date: Nov. 9, 2023

(54) ELECTRODE PLATE AND ELECTROCHEMICAL APPARATUS

(71) Applicant: ZHUHAI COSMX BATTERY CO., LTD., Zhuhai (CN)

(72) Inventors: Jian ZHANG, Zhuhai (CN); Yanyun ZHAI, Zhuhai (CN); Chong PENG, Zhuhai (CN)

(73) Assignee: ZHUHAI COSMX BATTERY CO., LTD., Zhuhai (CN)

(21) Appl. No.: 18/354,480

(22) Filed: Jul. 18, 2023

Related U.S. Application Data
(63) Continuation of application No. PCT/CN2022/080363, filed on Mar. 11, 2022.

(30) Foreign Application Priority Data
Mar. 11, 2021 (CN) 202110271076.8

(51) Int. Cl. H01M 50/533; H01M 4/13; H01M 4/66

(52) U.S. Cl. CPC H01M 50/533; H01M 4/13; H01M 4/667; H01M 4/668

(57) ABSTRACT

Disclosed are an electrode plate and an electrochemical apparatus. A first function surface of a current collector in the electrode plate includes a first active layer region and a first tab region, a second function surface of the current collector includes a second active layer region corresponding to the first active layer region and a second tab region corresponding to the first tab region, and an active layer is disposed in the first active layer region and/or the second active layer region. The first tab region is provided with N through holes penetrating to the second tab region, a tab passes through a through hole, and a first section of the tab is connected to the first tab region to form a first connection region and a second section of the tab is connected to the second tab region to form a second connection region, where N≥1.

### CROSS-REFERENCE TO RELATED APPLICATIONS

The present application is a continuation application of International Application No. PCT/CN2022/080363, filed on Mar. 11, 2022, which claims priority to Chinese Patent Application No. 202110271076.8, filed on Mar. 11, 2021. Both applications are incorporated herein by reference in their entireties.

### TECHNICAL FIELD

The present disclosure pertains to the technical field of lithium-ion batteries, and specifically relates to an electrode plate and an electrochemical apparatus.

### BACKGROUND

Since the first commercial lithium-ion battery was released by Sony in 1991, lithium-ion batteries have been widely used in fields such as consumer electronics, electric vehicles, and energy storage.

A conventional lithium-ion battery generally uses aluminum foil as a positive electrode current collector and copper foil as a negative electrode current collector. To improve energy density of the lithium-ion battery, aluminum foil or copper foil can be combined with a lighter polymer material to form a novel current collector, such as aluminum-polymer-aluminum current collector, and copper-polymer-copper current collector. The novel current collector with a sandwich structure not only has smaller surface density, but also can reduce weight of a lithium-ion battery and improve the energy density. Moreover, for the current collector with this structure, when a battery is short-circuited and temperature of the battery rises to a specific temperature, a polymer material is deformed, and then copper foil or aluminum foil falls off from the polymer, thereby cutting off current, and ensuring better safety than conventional copper foil and aluminum foil.

However, since the polymer material in the current collector with this structure is not conductive, and when a tab is welded to one side of the current collector, the other side of the current collector cannot be conducted, and thus a new welding method needs to be developed.

### SUMMARY

The present disclosure provides an electrode plate, and the electrode plate may conduct two surfaces of a current collector, and may improve energy density of a lithium-ion battery.

The present disclosure provides an electrochemical apparatus and the electrochemical apparatus has a high energy density.

The present disclosure provides an electrode plate, where the electrode plate includes a current collector, an active layer, and a tab. A first function surface of the current collector includes a first active layer region and a first tab region, a second function surface of the current collector includes a second active layer region corresponding to the first active layer region and a second tab region corresponding to the first tab region, and the active layer is disposed in the first active layer region and/or the second active layer region.

The first tab region is provided with N through holes penetrating to the second tab region, the tab passes through the through hole, and a first section of the tab is connected to the first tab region to form a first connection region and a second section of the tab is connected to the second tab region to form a second connection region, where N≥1.

According to the electrode plate described above, the tab further includes a third section, and the third section extends from a function surface of the current collector and is connected to an external tab.

According to the electrode plate described above, in a width direction of the current collector, a minimum distance between edges of M through holes and an edge of the current collector is W1, where W1≥1 mm, and M≤N.

According to the electrode plate described above, in the width direction of the current collector, a ratio of the minimum distance W1 between the edges of the M through holes and the edge of the current collector to a width W0 of the first tab region and/or the second tab region is (0.2-0.8):1.

According to the electrode plate described above, W0 ranges from 10 mm to 100 mm.

According to the electrode plate described above, in a length direction of the current collector, a minimum distance between the edges of the M through holes and an edge of the first active layer region and/or the second active layer region is L1, where L1≥2 mm.

According to the electrode plate described above, in a width direction of the current collector, a width of the first connection region and/or the second connection region ranges from 1 mm to ((W0/2)−2) mm.

According to the electrode plate described above, in the width direction of the current collector, a minimum distance between an edge of the first connection region and/or the second connection region and the edges of the M through holes is greater than or equal to 1 mm; and/or

in the width direction of the current collector, a minimum distance between an edge of the first connection region and/or the second connection region and the edge of the current collector is greater than or equal to 1 mm.

According to the electrode plate described above, a protective layer is disposed on the first function surface and/or the second function surface, the protective layer covers each of W through holes, and the protective layer has openings at corresponding positions of the W through holes, where W≤N.

According to the electrode plate described above, a thickness of the protective layer ranges from 0.5 μm to 50 μm.

According to the electrode plate described above, an area of the protective layer is 1.2-5 times an area of the W through holes.

According to the electrode plate described above, the current collector includes a first conductive layer, an insulation layer, and a second conductive layer that are stacked.

The first function surface is a surface, away from the insulation layer, of the first conductive layer, and the second function surface is a surface, away from the insulation layer, of the second conductive layer.

The present disclosure further provides an electrochemical apparatus, including the foregoing electrode plate.

The electrode plate provided in the present disclosure includes a current collector, an active layer, and a tab. A first function surface of the current collector includes a first active layer region and a first tab region, a second function surface of the current collector includes a second active layer region corresponding to the first active layer region and a second tab region corresponding to the first tab region, and the active layer is disposed in the first active layer region and/or the second active layer region. The first tab region is provided with N through holes penetrating to the second tab region, the tab passes through the through hole, and a first section of the tab is connected to the first tab region to form a first connection region and a second section of the tab is connected to the second tab region to form a second connection region, where N≥1. In the present disclosure, a first tab region is provided with a through hole penetrating to a second tab region, a tab passes through the through hole, and two ends of a tab are respectively connected to the first tab region and the second tab region, so that two sides of a current collector may be conducted, thereby improving energy density of a lithium-ion battery.

### BRIEF DESCRIPTION OF THE DRAWINGS

FIG. 1 is a top view of a current collector in the present disclosure.

FIG. 2 is a top view of an electrode plate according to an embodiment of the present disclosure.

FIG. 3 is a first cross-sectional view taken along the line X-X in FIG. 2 of the present disclosure.

FIG. 4 is a second cross-sectional view taken along the line X-X in FIG. 2 of the present disclosure.

FIG. 5 is a top view of an electrode plate according to another embodiment of the present disclosure.

FIG. 6 is a top view of an electrode plate according to another embodiment of the present disclosure.

FIG. 7 is a cross-sectional view taken along the line X-X in FIG. 5 or FIG. 6 of the present disclosure.

FIG. 8 is a top view of an electrode plate according to another embodiment of the present disclosure.

FIG. 9 is a first cross-sectional view taken along the line X-X in FIG. 8 of the present disclosure.

FIG. 10 is a second cross-sectional view taken along the line X-X in FIG. 8 of the present disclosure.

FIG. 11 is a schematic structural diagram of a jelly roll in Examples 1, 4, and 5 of the present disclosure.

FIG. 12 is a schematic structural diagram of a jelly roll in Example 2 of the present disclosure.

FIG. 13 is a schematic structural diagram of a jelly roll in Example 3 of the present disclosure.

### DETAILED DESCRIPTION OF THE EMBODIMENTS

The following clearly describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

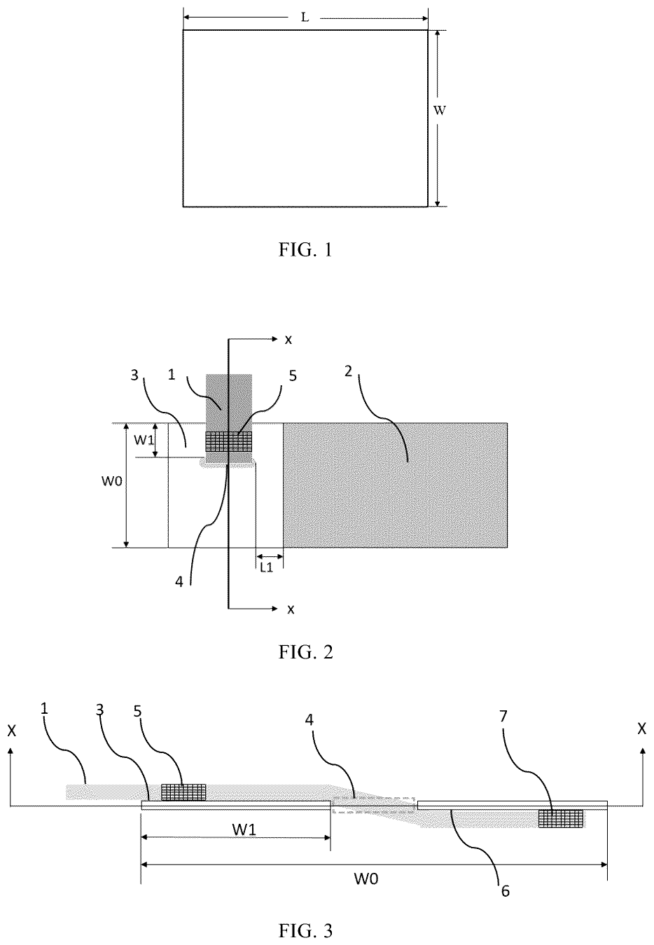

FIG. 1 is a top view of a current collector in the present disclosure. As shown in FIG. 1, for all definitions of “length” and “width” described below, reference may be made to a “length direction L” and a “width direction W” of the current collector. For example, either or both of a first function surface and a second function surface (the first function surface and the second function surface refer to two largest and opposite surfaces, for an electrode active layer to be coated, of the current collector) of the current collector are rectangles. The length direction L of the current collector is a direction in which the largest side length of a function surface of the current collector is located, and the width direction W of the current collector is a direction in which the smallest side length of a function surface of the current collector is located. For example, when a width of a first tab region and/or a second tab region is defined as W0 in the present disclosure, a size of the first tab region and/or the second tab region is W0 in a width direction of the current collector.

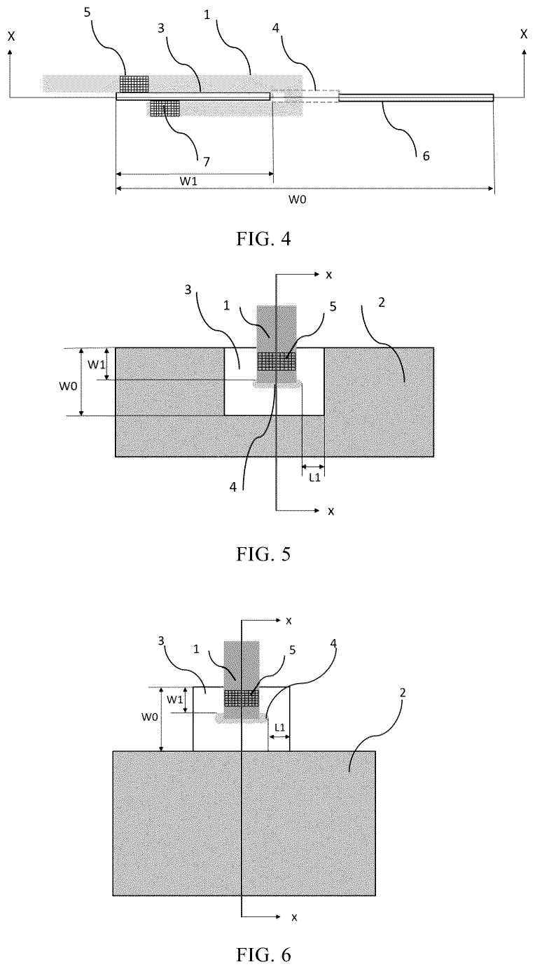

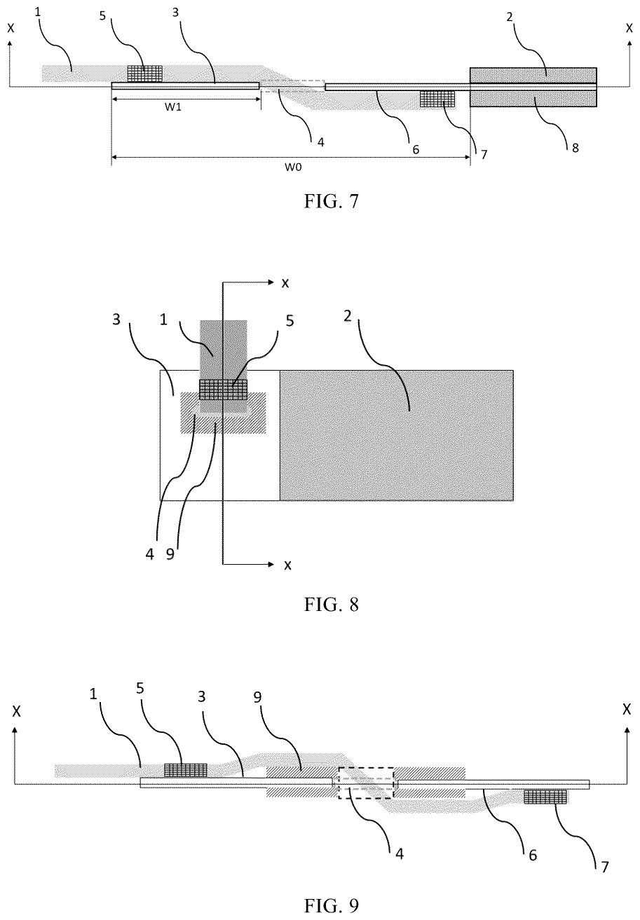

FIG. 2 is a top view of an electrode plate according to an embodiment of the present disclosure. FIG. 3 is a first cross-sectional view taken along the line X-X in FIG. 2 of the present disclosure. FIG. 4 is a second cross-sectional view taken along the line X-X in FIG. 2 of the present disclosure. FIG. 5 is a top view of an electrode plate according to another embodiment of the present disclosure. FIG. 6 is a top view of an electrode plate according to another embodiment of the present disclosure. FIG. 7 is a cross-sectional view taken along the line X-X in FIG. 5 or FIG. 6 of the present disclosure. As shown in FIG. 2 to FIG. 7, the present disclosure provides an electrode plate including a current collector, an active layer, and a tab 1. A first function surface of the current collector includes a first active layer region 2 and a first tab region 3, a second function surface of the current collector includes a second active layer region 8 corresponding to the first active layer region 2 and a second tab region 6 corresponding to the first tab region 3, and the active layer is disposed in the first active layer region 2 and/or the second active layer region 8.

The first tab region 3 is provided with N through holes 4 penetrating to the second tab region 6, the tab 1 passes through a through hole 4, and a first section of the tab 1 is connected to the first tab region 3 to form a first connection region 5 and a second section of the tab 1 is connected to the second tab region 6 to form a second connection region 7, where N≥1.

Specific positions of the first tab region 3 and the first active layer region 2 are not limited in the present disclosure. As shown in FIG. 2, the first tab region 3 in the present disclosure may be disposed on a side in a length direction of the first active layer region 2. As shown in FIG. 5, the first tab region 3 in the present disclosure may alternatively be disposed on a side in a width direction of the first active layer region 2, and three sides of the first tab region 3 are adjacent to the first active layer region 2. As shown in FIG. 6, the first tab region 3 in the present disclosure may alternatively be disposed on a side in a width direction of the first active layer region 2, and one side of the first tab region 3 is adjacent to the first active layer region 2.

In the present disclosure, the second tab region 6 corresponds to the first tab region 3, and the second active layer region 8 corresponds to the first active layer region 2. It may be understood that a projection of the second tab region 6 on the first tab region 3 coincides fully with the first tab region 3, and a projection of the second active layer region 8 on the first active layer region 2 coincides fully with the first active layer region 2. The active layer in the present disclosure may be disposed at the first active layer region 2, may be disposed at the second active layer region 8, or may be disposed at both the first active layer region 2 and the second active layer region 8.

In the present disclosure, the first tab region 3 is provided with N through holes 4 penetrating to the second tab region 6, and the tab 1 passes through a through hole 4. It may be understood that the electrode plate in the present disclosure may have n tabs 1, where n≤N. When n is equal to N, each tab 1 passes through one through hole 4, a first section of each tab 1 is connected to the first tab region 3 to form a first connection region 5, and a second section of each tab 1 is connected to the second tab region 6 to form a second connection region 7. When n<N, each tab 1 passes through one through hole 4, a first section of each tab 1 is connected to the first tab region 3 to form a first connection region 5, a second section of each tab 1 is connected to the second tab region 6 to form a second connection region 7, and a remaining through hole 4 is reserved.

In the present disclosure, the tab 1 further includes a third section, and the third section extends from a function surface of the current collector and is configured to be connected to an external tab.

A shape of the through hole 4 is not limited in the present disclosure, and any shape of a through hole through which the tab 1 may pass is within the protection scope of the present disclosure. In some implementations, the shape of the through hole 4 may be rectangular, circular, polyhedral, or rectangular+semicircular. In a specific implementation, the shape of the through hole 4 is rectangular+semicircular.

In the present disclosure, the first connection region 5 refers to a position where the tab 1 and the first tab region 3 are fixed, and the second connection region 7 refers to a position where the tab 1 and the second tab region 6 are fixed. If the tab 1 is welded to the first tab region 3 and the second tab region 6 separately, the first connection region 5 is a region in which a solder joint formed when the tab 1 is welded to the first tab region 3 is located, and the second connection region 7 is a region in which a solder joint formed when the tab 1 is welded to the second tab region 6 is located.

Specific positions of the first connection region 5 and the second connection region 7 are not limited in the present disclosure. As shown in FIG. 3, the first connection region 5 and the second connection region 7 may be located on two sides of the through hole 4, respectively. As shown in FIG. 4, the first connection region 5 and the second connection region 7 may be located on a same side of the through hole 4.

A specific structure of the current collector is not limited in the present disclosure. In a specific implementation, the current collector includes a first conductive layer, an insulation layer, and a second conductive layer that are stacked; and the first function surface is the first conductive layer and the second function surface is the second conductive layer. For a current collector with such a structure, when a battery is short-circuited, and when a temperature of the battery rises to a specific value, the insulation layer may swell, so that the first conductive layer and the second conductive layer fall off from the insulation layer, internal current of the battery is cut off, and safety of the battery is improved.

A material of the first conductive layer or the second conductive layer may be a metal or an alloy, which includes, but is not limited to, at least one of aluminum, copper, nickel, silver, gold, or iron. The materials of the first conductive layer and the second conductive layer may be the same or different.

A material of the insulation layer may be a polymer including, but not limited to, at least one of Polyethylene terephthalate (PET), Polypropylene (PP), Polyethylene (PE), Polyimide (PI), Polyether ketone (PEK), or Polyphenylene sulfide (PPS).

A transition layer may be further included between the first conductive layer and the insulation layer and/or between the second conductive layer and the insulation layer, and a material of the transition layer includes, but is not limited to, at least one of aluminum oxide, magnesium oxide, or titanium oxide.

The first conductive layer, the second conductive layer, or the insulation layer may further be provided with a through hole. A specific shape of the through hole is not limited in the present disclosure. The shape of the through hole may be rectangular, circular, polyhedral, or rectangular+semicircular. In a specific implementation, the shape of the through hole is rectangular+semicircular.

The electrode plate in the present disclosure may be a positive electrode plate or may be a negative electrode plate.

When the electrode plate is a positive electrode plate, the active layer in the present disclosure is a positive electrode active layer disposed on a surface of a positive electrode current collector. The positive electrode active layer is obtained by drying a positive electrode active slurry, and the positive electrode active slurry includes a positive electrode active material, a conductive agent, and a binder. The positive electrode active material includes at least one of Lithium Cobalt Oxide (LCO), Nickel Cobalt Manganese ternary material (NCM), Nickel Cobalt Aluminum ternary material (NCA), Nickel Cobalt Manganese Aluminum quaternary material (NCMA), Lithium Ferrous Phosphate (LFP), Lithium Manganese Phosphate (LMP), Lithium Vanadium Phosphate (LVP), Lithium Manganate Oxide (LMO), or a lithium-rich manganese-base material.

When the electrode plate is a negative electrode plate, the active layer in the present disclosure is a negative electrode active layer disposed on a surface of a negative electrode current collector. The negative electrode active layer is obtained by drying a negative electrode active slurry, and the negative electrode active slurry includes a negative electrode active material, a conductive agent, and a binder. The negative electrode active material includes at least one of graphite, mesocarbon microbead, soft carbon, hard carbon, a silicon material, a silicon oxide material, a silicon carbon material, or lithium titanate.

The conductive agent in the positive electrode active slurry and the negative electrode active slurry includes at least one of conductive carbon black, carbon nanotubes, conductive graphite, or graphene.

The binder in the positive electrode active slurry and the negative electrode active slurry includes at least one of polyvinylidene fluoride, a copolymer of vinylidene fluoride-hexafluoropropylene, polyamide, polyacrylonitrile, polyacrylic acid ester, polyacrylic acid, polyacrylate, sodium carboxymethyl cellulose, polyvinylpyrrolidone, polyvinyl ether, polymethyl methacrylate, polytetrafluoroethylene, polyhexafluoropropylene, or styrene-butadiene rubber.

In the present disclosure, the through hole 4 penetrating through the first tab region 3 and the second tab region 6 is provided, the tab 1 passes through the through hole 4, the first section of the tab 1 is connected to the first tab region 3, and the second section of the tab 1 is connected to the second tab region 6, so that two sides of the current collector may be conducted, thereby improving energy density of a lithium-ion battery.

As shown in FIG. 2 to FIG. 7, in some implementations of the present disclosure, in a width direction of the current collector, a minimum distance between edges of M through holes 4 and an edge of the current collector is W1, where W1≥1 mm, and M≤N.

In the present disclosure, the minimum distance between edges of the through holes 4 and an edge of the current collector means a distance between an edge of the closest through hole and the edge of the current collector. It may be understood that, in the present disclosure, a minimum distance between edges of at least M through holes 4 and the edge of the current collector is W1, where W1≥1 mm. A specific distance is reserved between the edges of the through holes 4 and the current collector, so that service life of the electrode plate may be prolonged.

As shown in FIG. 2 to FIG. 7, in some implementations of the present disclosure, in the width direction of the current collector, a ratio of the minimum distance W1 between the edges of the M through holes 4 and the edge of the current collector to a width W0 of the first tab region 3 and/or the second tab region 6 is (0.2-0.8):1.

In the present disclosure, if the ratio of W1 to W0 is too large, it means that an area of a through hole 4 is too small to be passed through by the tab 1. If the ratio of W1 to W0 is too small, it means that an area of a through hole 4 is too large, the electrode plate is easily damaged during long-term use, and service life is short. The ratio of W1 to W0 is defined as (0.2-0.8):1 in the present disclosure, so that the tab 1 may be allowed to pass through the through hole 4 normally while ensuring the service life of the electrode plate. In a specific implementation, W0 ranges from 10 mm to 100 mm.

As shown in FIG. 2 to FIG. 7, in some implementations of the present disclosure, in a length direction of the current collector, a minimum distance between the edges of the M through holes 4 and an edge of the first active layer region 2 and/or the second active layer region 8 is L1, where L1≥2 mm. With this arrangement, the service life of the electrode plate may be prolonged.

In some implementations of the present disclosure, in the width direction of the current collector, a width of the first connection region 5 and/or the second connection region 7 ranges from 1 mm to ((W0/2)−2) mm.

In the present disclosure, when the width of the first connection region 5 and/or the second connection region 7 is too large, the energy density of the electrode plate is reduced. When the width of the first connection region 5 and/or the second connection region 7 is too small, the service life of the electrode plate is short. In the present disclosure, the width of the first connection region 5 and/or the second connection region 7 is defined as ranging from 1 mm to ((W0/2)−2) mm, so that the service life of the electrode plate may be prolonged while ensuring the energy density of the electrode plate.

In some implementations of the present disclosure, in the width direction of the current collector, a minimum distance between an edge of the first connection region 5 and/or the second connection region 7 and the edges of the M through holes 4 is greater than or equal to 1 mm; and/or

in the width direction of the current collector, a minimum distance between an edge of the first connection region 5 and/or the second connection region 7 and the edge of the current collector is greater than or equal to 1 mm. With this arrangement, the service life of the electrode plate may be prolonged.

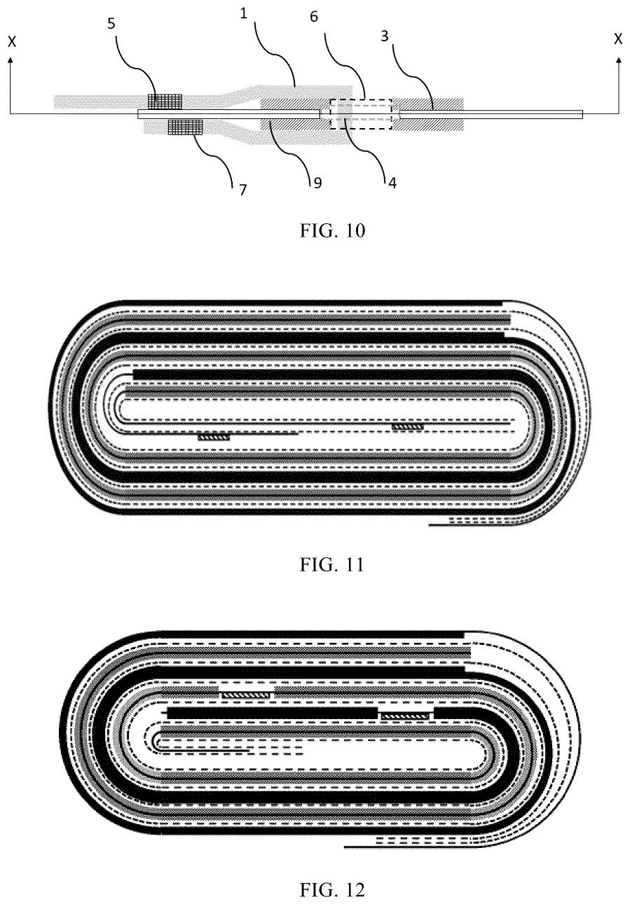

FIG. 8 is a top view of an electrode plate according to another embodiment of the present disclosure. FIG. 9 is a first cross-sectional view taken along the line X-X in FIG. 8 of the present disclosure. FIG. 10 is a second cross-sectional view taken along the line X-X in FIG. 8 of the present disclosure. As shown in FIG. 8 to FIG. 10, in some implementations of the present disclosure, in order to protect a through hole 4 and prevent the through hole 4 from cracking, and improve the service life of the electrode plate, a protective layer 9 is disposed on the first function surface and/or the second function surface, the protective layer 9 covers each of the W through holes 4, and the protective layer 9 has openings at corresponding positions of the W through holes 4, where W≤N.

A specific type of the protective layer 9 is not limited in the present disclosure, and the protective layer 9 may be an insulating material or a conductive material. In a specific implementation, the protective layer 9 may be a protective adhesive paper or ceramic layer. The corresponding positions of the W through holes 4 refer to positions of projections of the W through holes 4 on the protective layer 9. It may be understood that the protective layer 9 has an opening at a through hole 4, and a size and a shape of the opening of the protective layer 9 may be the same as or different from those of the through hole 4.

In some implementations of the present disclosure, a thickness of the protective layer 9 ranges from 0.5 μm to 50 μm.

In the present disclosure, if the thickness of the protective layer 9 is too thick, the energy density of the electrode plate is reduced; if the thickness of the protective layer 9 is too thin, the service life of the electrode plate is short since the through hole 4 cannot be sufficiently protected. The thickness of the protective layer 9 is defined as ranging from 0.5 μm to 50 μm in the present disclosure, which not only protects the through holes 4 and increases the service life of the electrode plate, but also does not reduce the energy density of the electrode plate.

In some implementations of the present disclosure, an area of the protective layer 9 is 1.2-5 times an area of the W through holes 4.

In the present disclosure, if the area of the protective layer 9 (including an area of an opening of the protective layer 9) is too large, the energy density of the electrode plate is reduced, and connection of the tab 1 with the first tab region 3 and/or the second tab region 6 is adversely affected. If the area of the protective layer 9 is too small, the service life of the electrode plate is short since the through holes 4 cannot be sufficiently protected. The area of the protective layer 9 is defined as 1.2-5 times the area of the through holes 4 in the present disclosure, so that the energy density of the electrode plate may be ensured, the tab 1 may be normally connected to the first tab region 3 and/or the second tab region 6, and the through holes 4 may also be protected, so as to improve the service life of the electrode plate.

A second aspect of the present disclosure provides an electrochemical apparatus, including the foregoing electrode plate and further including an outer package and an electrolyte.

The outer package may be an aluminum-plastic film, and the electrolyte may include a lithium salt and a non-aqueous solvent. The lithium salt is not specifically limited in the present disclosure, and any lithium salt known in the art may be used provided that the purpose of the present disclosure can be achieved. For example, the lithium salt may include at least one of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, or LiPO₂F₂. In the present disclosure, the non-aqueous solvent is not particularly limited, provided that the purpose of the present disclosure can be achieved. For example, the non-aqueous solvent may include at least one of a carbonate compound, a carboxylate compound, an ether compound, a nitrile compound, or another organic solvent.

The electrochemical apparatus in the present disclosure includes the foregoing electrode plate, so that the electrochemical apparatus may have high energy density.

Hereinafter, the technical solutions of the present disclosure will be further described in combination with specific embodiments. All parts, percentages of, and ratios recorded in the following embodiments are based on masses, all reagents used in the embodiments are commercially available or synthesized in a conventional manner, and may be used directly without further treatment, and all instruments used in the embodiments are commercially available.

### Example 1

A lithium-ion battery in this example is obtained according to the following steps.

(1) Preparation of a Positive Electrode Plate

A positive electrode current collector is a current collector of an Al-PET-Al structure. As shown in FIG. 8 and FIG. 9, the positive electrode current collector includes a first tab region 3 and a first active layer region 2 in a length direction, a second tab region 6 is disposed in correspondence with the first tab region 3, and a second active layer region 8 is disposed in correspondence with the first active layer region 2. The first tab region 3 is provided with a through hole 4 penetrating to the second tab region 6, and a shape of the through hole 4 is rectangular+semicircular.

A lithium cobalt oxide active slurry is applied to the first active layer region 2 and the second active layer region 8; a protective layer 9 is provided in the first tab region 3 and the second tab region 6, and the protective layer 9 is a protective adhesive paper; and then an opening is formed on the protective adhesive paper at the through hole 4, and a shape of the opening is rectangular+semicircular. A mass composition of the lithium cobalt oxide active slurry is as follows: lithium cobalt oxide:conductive carbon black:conductive carbon tube:Polyvinylidene fluoride (PVDF)=97%:1%:0.5%:1.5%. A thickness of the protective adhesive paper is 12 μm, and a ratio of an area of the opening of the adhesive paper to an area of the through hole 4 is 1:1.

A tab 1 made of Al is inserted into the through hole 4, a first section of the tab 1 is welded to the first tab region 3 to form a first connection region 5, and a second section of the tab 1 is welded to the second tab region 6 to form a second connection region 7. The first connection region 5 and the second connection region 7 are located on two sides of the through hole 4. In this way, the positive electrode plate is obtained. A width of the first connection region 5 and/or the second connection region 7 is 35 mm.

(2) Preparation of a Negative Electrode Plate

A negative electrode current collector is Cu foil. A graphite active slurry is applied to two surfaces of the negative electrode current collector, and a tab is welded to an area where the graphite active slurry is not applied. In this way, the negative electrode plate is obtained.

A mass composition of the graphite active slurry is as follows: graphite:conductive carbon black:styrene-butadiene rubber:sodium carboxymethyl cellulose=96%:1.5%:1.5%:1%.

(3) Preparation of a Lithium-Ion Battery

FIG. 11 is a schematic structural diagram of a jelly roll in Examples 1, 4, and 5 of the present disclosure. As shown in FIG. 11, the positive electrode plate in step (1), the negative electrode plate in step (2), and a separator are wound to obtain the jelly roll; and the lithium-ion battery is obtained after processes of packaging, electrolyte injection, formation, secondary sealing, and grading.

### Example 2

A lithium-ion battery in this example is obtained according to the following steps.

(1) Preparation of a Positive Electrode Plate

A positive electrode current collector is a current collector of an Al—Al₂O₃-PET-Al₂O₃—Al structure. As shown in FIG. 5 and FIG. 7, the positive electrode current collector includes a first tab region 3 and a first active layer region 2 in a width direction, and three sides of the first tab region 3 are adjacent to the first active layer region 2. A second tab region 6 is disposed in correspondence with the first tab region 3, a second active layer region 8 is disposed in correspondence with the first active layer region 2, the first tab region 3 is provided with a through hole 4 penetrating to the second tab region 6, and a shape of the through hole 4 is rectangular+semicircular.

A lithium cobalt oxide active slurry is applied to the first active layer region 2 and the second active layer region 8, and a mass composition of the lithium cobalt oxide active slurry is 1%: 0.5%: 1.5%.

A tab 1 made of Al is inserted into the through hole 4, a first section of the tab 1 is welded to the first tab region 3 to form a first connection region 5, and a second section of the tab 1 is welded to the second tab region 6 to form a second connection region 7. The first connection region 5 and the second connection region 7 are located on two sides of the through hole 4. In this way, the positive electrode plate is obtained. A width of the first connection region 5 and/or the second connection region 7 is 8 mm.

(2) Preparation of a Negative Electrode Plate

A negative electrode current collector is Cu foil. A graphite active slurry is applied to two surfaces of the negative electrode current collector, and a nickel tab is welded to either surface of the negative electrode current collector by ultrasonic welding in an area where the graphite active slurry is not applied. In this way, the negative electrode plate is obtained.

A mass composition of the graphite active slurry is as follows: graphite:conductive carbon black:styrene-butadiene rubber:sodium carboxymethyl cellulose=96%:1.5%:1.5%:1%.

(3) Preparation of a Lithium-Ion Battery

FIG. 12 is a schematic structural diagram of a jelly roll of Example 2 of the present disclosure. As shown in FIG. 12, the positive electrode plate in step (1), the negative electrode plate in step (2), and a separator are wound to obtain the jelly roll; and the lithium-ion battery is obtained after processes of packaging, electrolyte injection, formation, secondary sealing, and grading.

### Example 3

A lithium-ion battery in this example is obtained according to the following steps.

(1) Preparation of a Positive Electrode Plate

A positive electrode current collector is a current collector of an Al-PP-Al structure. As shown in FIG. 6 and FIG. 7, the positive electrode current collector includes a first tab region 3 and a first active layer region 2 in a width direction, and one side of the first tab region 3 is adjacent to the first active layer region 2. A second tab region 6 is disposed in correspondence with the first tab region 3, a second active layer region 8 is disposed in correspondence with the first active layer region 2, the first tab region 3 is provided with a through hole 4 penetrating to the second tab region 6, and a shape of the through hole 4 is rectangular+semicircular.

A lithium cobalt oxide active slurry is applied to the first active layer region 2 and the second active layer region 8, and a mass composition of the lithium cobalt oxide active slurry is 1%: 0.5%: 1.5%.

A tab 1 made of Al is inserted into the through hole 4, a first section of the tab 1 is welded to the first tab region 3 to form a first connection region 5, and a second section of the tab 1 is welded to the second tab region 6 to form a second connection region 7. The first connection region 5 and the second connection region 7 are located on two sides of the through hole 4. In this way, the positive electrode plate is obtained. A width of the first connection region 5 and/or the second connection region 7 is 3 mm.

(2) Preparation of a Negative Electrode Plate

A negative electrode current collector is Cu foil. A graphite active slurry is applied to two surfaces of the negative electrode current collector, and a tab is welded to an area where the graphite active slurry is not applied. In this way, the negative electrode plate is obtained.

A mass composition of the graphite active slurry is as follows: graphite:conductive carbon black:styrene-butadiene rubber:sodium carboxymethyl cellulose=96%:1.5%:1.5%:1%.

(3) Preparation of a Lithium-Ion Battery

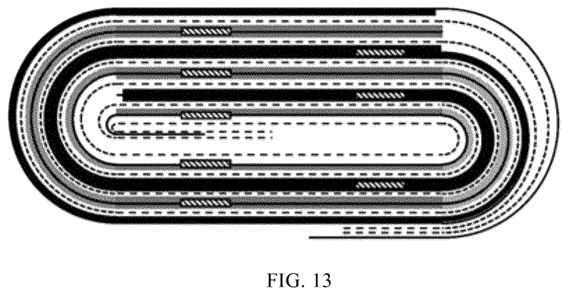

FIG. 13 is a schematic structural diagram of a jelly roll in Example 3 of the present disclosure. As shown in FIG. 13, the positive electrode plate in step (1), the negative electrode plate in step (2), and a separator are wound to obtain the jelly roll; and the lithium-ion battery is obtained after processes of packaging, electrolyte injection, formation, secondary sealing, and grading.

### Example 4

A lithium-ion battery in this example is obtained according to the following steps.

(1) Preparation of a Positive Electrode Plate

A positive electrode current collector is Al foil. A lithium cobalt oxide active slurry is applied to two surfaces of the positive electrode current collector, and an aluminum tab is welded to either surface of the positive electrode current collector by ultrasonic welding in an area where the lithium cobalt oxide active slurry is not applied. In this way, the positive electrode plate is obtained.

A mass composition of the lithium cobalt oxide active slurry is as follows: lithium cobalt oxide:conductive carbon black:conductive carbon tube:PVDF=97%:1%:0.5%:1.5%.

(2) Preparation of a Negative Electrode Plate

A negative electrode current collector is a current collector of a Cu-PET-Cu structure. As shown in FIG. 8 and FIG. 9, the negative electrode current collector includes a first tab region 3 and a first active layer region 2 in a length direction, a second tab region 6 is disposed in correspondence with the first tab region 3, and a second active layer region 8 is disposed in correspondence with the first active layer region 2. The first tab region 3 is provided with a through hole 4 penetrating to the second tab region 6, and a shape of the through hole 4 is rectangular+semicircular.

A graphite active slurry is applied to the first active layer region 2 and the second active layer region 8; a protective layer 9 is provided in the first tab region 3 and the second tab region 6, and the protective layer 9 is a protective adhesive paper; and then an opening is formed on the protective adhesive paper at the through hole 4, and a shape of the opening is rectangular+semicircular. A mass composition of the negative active slurry is as follows: graphite:conductive carbon black:styrene-butadiene rubber:sodium carboxymethyl cellulose=96%:1.5%:1.5%:1%. A thickness of the protective adhesive paper is 12 μm, and a ratio of an area of the opening of the adhesive paper to an area of the through hole 4 is 1:1.

A tab 1 made of Ni is inserted into the through hole 4, a first section of the tab 1 is welded to the first tab region 3 to form a first connection region 5, and a second section of the tab 1 is welded to the second tab region 6 to form a second connection region 7. The first connection region 5 and the second connection region 7 are located on two sides of the through hole 4. In this way, the negative electrode plate is obtained. A width of the first connection region 5 and/or the second connection region 7 is 35 mm.

(3) Preparation of a Lithium-Ion Battery

As shown in FIG. 11, the positive electrode plate in step (1), the negative electrode plate in step (2), and a separator are wound to obtain a jelly roll; and the lithium-ion battery is obtained after processes of packaging, electrolyte injection, formation, secondary sealing, and grading.

### Example 5

A lithium-ion battery in this example is obtained according to the following steps.

(1) Preparation of a Positive Electrode Plate

A positive electrode current collector is a current collector of an Al-PET-Al structure. As shown in FIG. 8 and FIG. 9, the positive electrode current collector includes a first tab region 3 and a first active layer region 2 in a length direction, a second tab region 6 is disposed in correspondence with the first tab region 3, and a second active layer region 8 is disposed in correspondence with the first active layer region 2. The first tab region 3 is provided with a through hole 4 penetrating to the second tab region 6, and a shape of the through hole 4 is rectangular+semicircular.

A lithium cobalt oxide active slurry is applied to the first active layer region 2 and the second active layer region 8; a protective layer 9 is provided in the first tab region 3 and the second tab region 6, and the protective layer 9 is a protective adhesive paper; and then an opening is formed on the protective adhesive paper at the through hole 4, and a shape of the opening is rectangular+semicircular. A mass composition of the lithium cobalt oxide active slurry is as follows: lithium cobalt oxide:conductive carbon black:conductive carbon tube:PVDF=97%:1%:0.5%:1.5%. A thickness of the protective adhesive paper is 12 μm, and a ratio of an area of the opening of the adhesive paper to an area of the through hole 4 is 1:1.

A tab 1 made of Al is inserted into the through hole 4, a first section of the tab 1 is welded to the first tab region 3 to form a first connection region 5, and a second section of the tab 1 is welded to the second tab region 6 to form a second connection region 7. The first connection region 5 and the second connection region 7 are located on two sides of the through hole 4. In this way, the positive electrode plate is obtained. A width of the first connection region 5 and/or the second connection region 7 is 35 mm.

(2) Preparation of a Negative Electrode Plate

A negative electrode current collector is a current collector of a Cu-PET-Cu structure. As shown in FIG. 8 and FIG. 9, the negative electrode current collector includes a first tab region 3 and a first active layer region 2 in a length direction, a second tab region 6 is disposed in correspondence with the first tab region 3, and a second active layer region 8 is disposed in correspondence with the first active layer region 2. The first tab region 3 is provided with a through hole 4 penetrating to the second tab region 6, and a shape of the through hole 4 is rectangular+semicircular.

A graphite active slurry is applied to the first active layer region 2 and the second active layer region 8. A protective adhesive paper 9 is attached to the first tab region 3 and the second tab region 6, an opening is formed on the protective adhesive paper 9 at the through hole 4, and a shape of the opening is rectangular+semicircular. A mass composition of the negative active slurry is as follows: graphite:conductive carbon black:styrene-butadiene rubber:sodium carboxymethyl cellulose=96%:1.5%:1.5%:1%. A thickness of the protective adhesive paper is 12 μm, and a ratio of an area of the opening of the adhesive paper to an area of the through hole 4 is 1:1.

A tab 1 made of Ni is inserted into the through hole 4, a first section of the tab 1 is welded to the first tab region 3 to form a first connection region 5, and a second section of the tab 1 is welded to the second tab region 6 to form a second connection region 7. The first connection region 5 and the second connection region 7 are located on two sides of the through hole 4. In this way, the negative electrode plate is obtained. A width of the first connection region 5 and/or the second connection region 7 is 35 mm.

(3) Preparation of a Lithium-Ion Battery

As shown in FIG. 11, the positive electrode plate in step (1), the negative electrode plate in step (2), and a separator are wound to obtain a jelly roll; and the lithium-ion battery is obtained after processes of packaging, electrolyte injection, formation, secondary sealing, and grading.

### Comparative Example 1

A lithium-ion battery in this comparative example is obtained according to the following steps.

A positive electrode current collector is Al foil. A lithium cobalt oxide active slurry is applied to two surfaces of the positive electrode current collector, and a tab is welded to an area where the lithium cobalt oxide active slurry is not applied. In this way, a positive electrode plate is obtained.

A negative electrode current collector is Cu foil. A graphite active slurry is applied to two surfaces of the negative electrode current collector, and a tab is welded to an area where the graphite active slurry is not applied. In this way, a negative electrode plate is obtained.

A mass composition of the lithium cobalt oxide active slurry is as follows: lithium cobalt oxide:conductive carbon black:conductive carbon tube:PVDF=97%:1%:0.5%:1.5%. A mass composition of the graphite active slurry is as follows: graphite:conductive carbon black:styrene-butadiene rubber:sodium carboxymethyl cellulose=96%:1.5%:1.5%:1%.

The positive electrode plate, the negative electrode plate, and a separator are wound to obtain a jelly roll; and the lithium-ion battery is obtained after processes of packaging, electrolyte injection, formation, secondary sealing, and grading.

Performance Test

(1) Heavy Impact Test

A lithium-ion battery is fully charged, and the lithium-ion battery is placed on a plane; a steel column with a diameter of 15.8±0.2 mm is placed in the center of the lithium-ion battery, with the longitudinal axis of the steel column parallel to the plane; and a heavy object with a weight of 9.1±0.1 kg falls freely from a height of 610±25 mm onto the steel column above the lithium-ion battery. 20 lithium-ion batteries obtained from a same example or comparative example are tested in parallel to calculate a heavy impact pass rate of the lithium-ion battery. Test results are shown in Table 1.

(2) Energy Density

A lithium-ion battery is fully charged at 0.2C, and then discharged to 3.0V at 0.2C. The discharge energy E is recorded, and a mass of the battery is measured by using an electronic balance, denoted as m. Battery energy density ED=E/m.

TABLE 1
Performance test results of batteries in
the Examples and Comparative Examples

| | Energy density | |
|---|---|---|
| Item | (Wh/kg) | Heavy impact (pass/test) |
| Example 1 | 292 | 20/20 |
| Example 2 | 300 | 20/20 |
| Example 3 | 286 | 20/20 |
| Example 4 | 295 | 4/20 |
| Example 5 | 310 | 20/20 |
| Comparative | 280 | 0/20 |
| Example 1 | | |

It may be learned from Table 1 that, the energy density of the lithium-ion batteries in Examples 1-5 of the present disclosure is greater than that of the lithium-ion battery in Comparative Example 1, and heavy impact performance of the lithium-ion batteries in Examples 1-5 of the present disclosure is superior to that of the lithium-ion battery in Comparative Example 1. Therefore, the lithium-ion batteries in the examples of the present application not only have high energy density, but also have good safety performance.

The embodiments in this specification are described in a related manner, the same or similar parts between the embodiments may refer to each other, and each embodiment focuses on differences from other embodiments.

The foregoing descriptions are merely preferred embodiments of the present disclosure, rather than limiting the protection scope of the present disclosure. Any modification, equivalent replacement, improvement, and the like made without departing from the spirit and principle of the present disclosure shall fall within the protection scope of the present disclosure.

What is claimed is:

1. An electrode plate, comprising a current collector, an active layer, and a tab, wherein
a first function surface of the current collector comprises a first active layer region and a first tab region, a second function surface of the current collector comprises a second active layer region corresponding to the first active layer region and a second tab region corresponding to the first tab region, and the active layer is disposed in the first active layer region and/or the second active layer region; and
the first tab region is provided with N through holes penetrating to the second tab region, the tab passes through the through hole, and a first section of the tab is connected to the first tab region to form a first connection region and a second section of the tab is connected to the second tab region to form a second connection region, wherein N≥1.

2. The electrode plate according to claim 1, wherein the tab further comprises a third section, and the third section extends from a function surface of the current collector and is connected to an external tab.

3. The electrode plate according to claim 1, wherein in a width direction of the current collector, a minimum distance between edges of M through holes and an edge of the current collector is W1, wherein W1≥1 mm, and M≤N.

4. The electrode plate according to claim 3, wherein in the width direction of the current collector, a ratio of the minimum distance W1 between the edges of the M through holes and the edge of the current collector to a width W0 of the first tab region and/or the second tab region is (0.2-0.8):1.

5. The electrode plate according to claim 4, wherein W0 ranges from 10 mm to 100 mm.

6. The electrode plate according to claim 1, wherein in a length direction of the current collector, a minimum distance between edges of M through holes and an edge of the first active layer region and/or the second active layer region is L1, wherein L1≥2 mm.

7. The electrode plate according to claim 1, wherein a width of the first tab region and/or the second tab region is W0, and in a width direction of the current collector, a width of the first connection region and/or the second connection region ranges from 1 mm to ((W0/2)−2) mm.

8. The electrode plate according to claim 1, wherein in a width direction of the current collector, a minimum distance between an edge of the first connection region and/or the second connection region and edges of M through holes is greater than or equal to 1 mm.

9. The electrode plate according to claim 1, wherein in a width direction of the current collector, a minimum distance between an edge of the first connection region and/or the second connection region and an edge of the current collector is greater than or equal to 1 mm.

10. The electrode plate according to claim 1, wherein a protective layer is disposed on the first function surface and/or the second function surface, the protective layer covers each of W through holes, and the protective layer has openings at corresponding positions of the W through holes, wherein W≤N.

11. The electrode plate according to claim 10, wherein a thickness of the protective layer ranges from 0.5 μm to 50 μm.

12. The electrode plate according to claim 10, wherein an area of the protective layer is 1.2-5 times an area of the W through holes.

13. The electrode plate according to claim 12, wherein the protective layer is a protective adhesive paper or a ceramic layer.

14. The electrode plate according to claim 1, wherein the current collector comprises a first conductive layer, an insulation layer, and a second conductive layer that are stacked; and
the first function surface is a surface, away from the insulation layer, of the first conductive layer, and the second function surface is a surface, away from the insulation layer, of the second conductive layer.

15. The electrode plate according to claim 14, wherein the current collector further comprises a transition layer disposed between the first conductive layer and the insulation layer and/or between the second conductive layer and the insulation layer.

16. The electrode plate according to claim 15, wherein a material of the transition layer comprises at least one of aluminum oxide, magnesium oxide, or titanium oxide.

17. The electrode plate according to claim 1, wherein the first tab region is disposed on a side in a length direction of the first active layer region.

18. The electrode plate according to claim 1, wherein the first tab region is disposed on a side in a width direction of the first active layer region, and three sides of the first tab region are adjacent to the first active layer region.

19. The electrode plate according to claim 1, wherein the first tab region is disposed on a side in a width direction of the first active layer region, and one side of the first tab region is adjacent to the first active layer region.

20. An electrochemical apparatus, comprising an electrode plate, wherein the electrode plate comprises a current collector, an active layer, and a tab, a first function surface of the current collector comprises a first active layer region and a first tab region, a second function surface of the current collector comprises a second active layer region corresponding to the first active layer region and a second tab region corresponding to the first tab region, and the active layer is disposed in the first active layer region and/or the second active layer region; and
the first tab region is provided with N through holes penetrating to the second tab region, the tab passes through the through hole, and a first section of the tab is connected to the first tab region to form a first connection region and a second section of the tab is connected to the second tab region to form a second connection region, wherein N≥1.
